(19) United States
(12) Patent Application Publication
(10) Pub. No.: US 2009/0132151 A1
(43) Pub. Date: May 21, 2009

(54) Fuel injection control method of engine and fuel injection control device for same

(75) Inventors: Naoaki Yanagisawa, Kanagawa-ken (JP); Kenji Seki, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi (JP)

(21) Appl. No.: 12/289,370

(22) Filed: Oct. 27, 2008

(30) Foreign Application Priority Data
Nov. 14, 2007 (JP) 2007-295301

(51) Int. Cl. F02D 41/30

(52) U.S. Cl. 701/105

(57) ABSTRACT

In a method of permitting an electronic control device 10A that is a fuel injection control device constituting a part of a fuel injection system of an engine 1 to generate a fuel injection signal depending on an engine operation state while determining fuel injection timing by an engine rotation signal, and to output the signal to an injector 5, thereby controlling fuel injection of the engine, the electronic control unit 10A continuously detects a supply voltage thereto, and recognizes starting of rotation of the engine 1 when it is detected that a predetermined fluctuation has occurred in the supply voltage at the time of starting or when it is determined that the supply voltage at the time of starting is below a predetermined reference voltage value, and starts fuel injection even before input of the engine rotation signal.

### BACKGROUND OF THE INVENTION

1. Field of the Invention

The present invention relates to a fuel injection control method of an engine, and a fuel injection control device, and in particular, relates to a fuel injection control method of an engine in which starting of the rotation of an engine is detected at the moment of engine starting to thereby determine a fuel injection, and a fuel injection control device executing the same method.

2. Description of the Related Art

In a multipurpose engine which requires simple construction and low cost, for example, like a conventional example disclosed in Japanese Patent Application Laid-Open No. 11-173246, it is general that a crank rotation signal is input to an electronic control unit only once during one rotation of an engine, and unless a crank rotor makes at least one rotation, starting of the rotation of an engine cannot be detected.

In a fuel injection control device which detects the rotation of an engine from a primary signal of a magnet-type ignition unit, an engine rotation signal cannot be detected unless an engine rotational speed becomes more than a predetermined speed at the moment of engine starting. Therefore, it is quite usual that initial several rotations at the moment of engine starting cannot be successfully detected by the fuel injection control methods.

Accordingly, in a case where a fuel injection control is performed on the basis of the rotation signal of an engine as described above, it takes a substantial time to detect the rotation of the engine. Therefore, occurrence of a first fuel injection will delay, and an engine-startability will be deteriorated, or a driver will have a worse feeling at the time of starting of an engine.

FIG. 6A to FIG. 6C are graphical views illustrating a relationship between an engine rotational speed and a fuel injection timing at the moment of an engine starting, and illustrating a timing of an ignition-signal and fluctuations in battery voltage at that time, in a case where an ignition signal is detected from a magnet-type ignition unit and a fuel injection control is executed. It can be understood from these graphs that, since the fuel injection control device cannot immediately detect a rotation signal even if an engine begins to rotate, the starting period of a fuel injection delays by one cycle. Also, since the time period for completion of one cycle is relatively as long as about 0.2 second to 0.8 second at the moment of engine starting having low rotational speed (about 500 rpm) as such, the delay of injection equivalent to one cycle gives a worse feeling to a driver at the moment of engine starting.

Meanwhile, in fuel injection systems for automobiles, it is quite usual to provide a number of teeth at the peripheral edge of a crank rotor to detect an engine rotation signal. In this case, the delay of fuel injection can be avoided by detecting the engine rotation signal immediately after the start of the rotation of the engine. However, provision of such a mechanism to the multipurpose engine will brings about a large cost increase.

### SUMMARY OF THE INVENTION

The invention is intended to solve the problems as described above, and the object thereof is to avoid any delay of fuel injection starting at the moment of engine starting without causing soaring of cost, and improve engine startability or feeling at the time of starting, in a fuel injection control system of an engine in which an engine rotation signal is input to a fuel injection control device only once per one complete rotation of an engine.

Thus, the present invention provides a control method which permits a fuel injection control device constituting a part of a fuel injection system of an engine to generate a fuel injection signal depending upon an engine operation state while determining a fuel injection timing by an input engine rotation signal, and to output the signal to an injector, thereby controlling fuel injection of the engine. Here, the fuel injection control device continuously detects a supply voltage thereto, and recognizes start of the rotation of the engine when it is detected that a predetermined fluctuation has occurred in the supply voltage at the time of starting of the fuel injection control device or when it is determined that the supply voltage at the time of starting of the fuel injection control device is below a predetermined reference voltage value, and starts fuel injection even before input of the engine rotation signal.

That is, by utilizing the facts that a supply voltage to the fuel injection control device drops temporarily by driving a starter motor at the moment of engine starting, and that the supply voltage rises from a low state at the time of restart of the fuel injection control device after being stopped due to a decrease in voltage accompanying power feeding to the starter motor, start of the rotation of the engine is recognized when a drop or rise in voltage is above a predetermined level from starting of the fuel injection control device, or when the supply voltage at the time of starting of the fuel injection control device is below a predetermined level. Thus, a fuel injection can be started even before inputting of an engine rotation signal without requiring complication of a system construction, or addition of expensive parts, and the delay of start of a fuel injection at the moment of engine starting can be avoided.

Further, the predetermined fluctuation of the supply voltage includes a case where a fluctuation has occurred above a predetermined falling voltage difference or rising voltage difference as a determination reference of engine starting from a voltage value at the time of starting of the fuel injection control device, and where a fluctuation has occurred within a predetermined period from starting of the fuel injection control device. According to this, driving of the starter motor or temporary stopping of the fuel injection control device can be detected by a simple sequence, so that start of the rotation of an engine can be rapidly and reliably recognized.

Moreover, in the aforementioned fuel injection control method of an engine, shifting to fuel injection control at the time of normal starting is made by detecting output of the engine rotation signal after start of rotation of the engine is recognized and a first fuel injection is performed. According to this, the fuel injection quantity required by an engine can be secured without delay.

Furthermore, a fuel injection control program for executing the fuel injection control method of an engine is stored in storage means, and the fuel injection control device is arranged in a fuel injection system of an engine such that electric power is supplied from a battery driving a starter motor, thereby executing the aforementioned fuel injection control method of an engine. According to this, the aforementioned fuel injection control method of an engine can be realized easily.

According to the invention which is adapted to recognize start of the rotation of an engine by utilizing a phenomenon that the supply voltage to the fuel injection control device changes rapidly by driving of the starter motor, it is possible to avoid delay of fuel injection start at the moment of engine starting without causing soaring of cost, and improve engine startability or feeling at the time of starting.

### BRIEF DESCRIPTION OF THE DRAWINGS

FIG. 1 is an arrangement drawing of a fuel injection control device illustrating an embodiment of the invention;

FIG. 2A is a graph illustrating control results by the fuel injection control device of FIG. 1;

FIG. 2B is a graph illustrating control results by the fuel injection control device of FIG. 1;

FIG. 2C is a graph illustrating control results by the fuel injection control device of FIG. 1;

FIG. 3A is a graph illustrating control results by the fuel injection control device of FIG. 1;

FIG. 3B is a graph illustrating control results by the fuel injection control device of FIG. 1;

FIG. 3C is a graph illustrating control results by the fuel injection control device of FIG. 1;

FIG. 4 is a flow chart illustrating a sequence of a fuel injection control method at the moment of engine starting by the fuel injection control device of FIG. 1;

FIG. 5 is a graph obtained when the engine rotational speed by the control of this embodiment is compared with the engine rotational speed by the control of a conventional specification;

FIG. 6A is a graphical view illustrating control results by a conventional example;

FIG. 6B is a graphical view illustrating control results by the conventional example; and

FIG. 6C is a graphical view illustrating control results by the conventional example.

### DESCRIPTION OF PREFERRED EMBODIMENTS

Hereinafter, a best mode of carrying out the invention will be described with reference to the accompanying drawings. In addition, in the invention, portions where the rotation of an engine starts before a fuel is combusted within a cylinder at the moment of engine starting shall also be included.

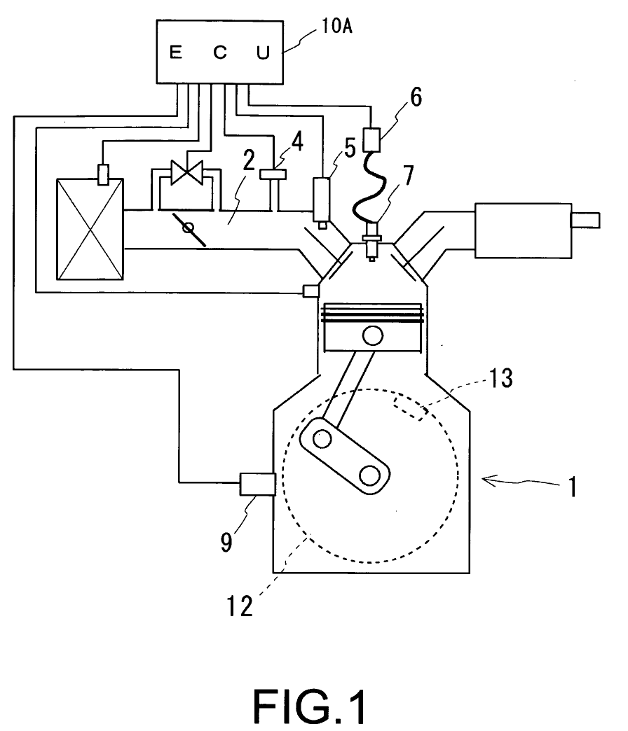

FIG. 1 shows an arrangement drawing of a fuel injection system in which an electronic control unit 10A that is a fuel injection control device of an engine of the this embodiment is arranged. It is assumed that the engine 1 is an engine such as a multipurpose engine which is simple in construction, and is low in manufacturing cost. In this system, the electronic control unit 10A detects a detection signal of a crank angle sensor 9 which is obtained as a magnet 13 provided at the peripheral edge of a crank rotor 12 of the engine 1 passes by the sensor as an engine rotation signal, and utilizes the rotation signal for determination of ignition timing by an ignition plug 7 via an ignition driver 6.

Further, the electronic control unit 10A generates a fuel injection signal which realizes a fuel injection quantity suited for engine operational conditions, using intake pipe pressure data detected by an intake pipe pressure sensor 4 or an engine rotation signal detected by the crank angle sensor 9, and outputs the generated fuel injection signal to an injector 5 disposed in the intake pipe 2, thereby executing a fuel injection control method.

In this embodiment, the electronic control unit 10A is adapted to be supplied with an electric current from a battery which drives a starter motor (not shown). However, fuel injection control of an engine to be described later is executed by a fuel injection control program stored in storage means of the electronic control unit 10A.

That is, the electronic control unit 10A is adapted to detect a supply voltage from the battery continuously from its starting, is adapted to recognize start of rotation of the engine 1, utilizing the phenomenon that a fluctuation accompanying driving of the starter motor is caused in a supply voltage detected before the engine rotation signal is input, and is adapted to output a first fuel injection signal to the injector 5 before the first engine rotation signal is input.

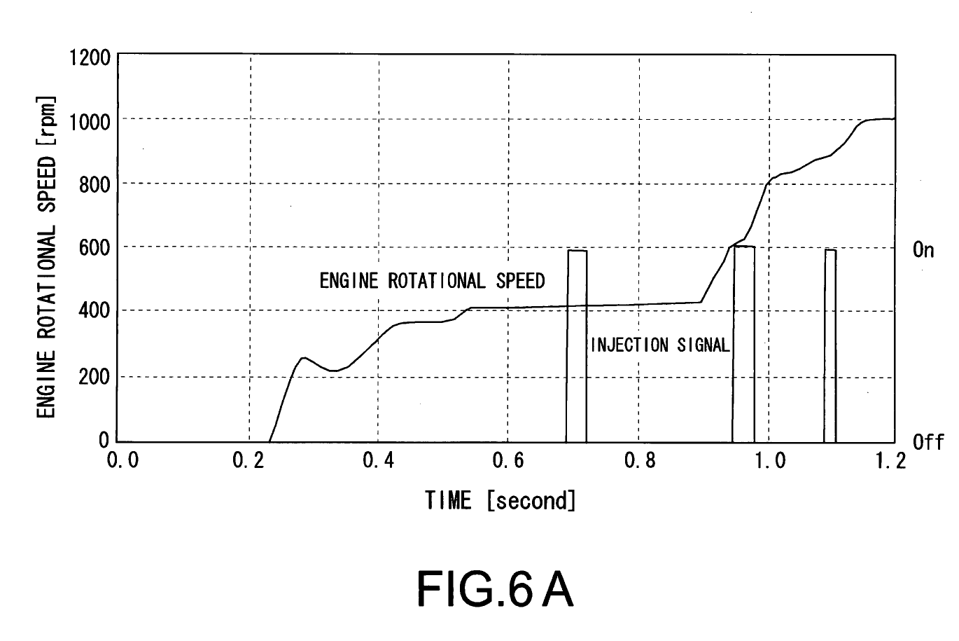

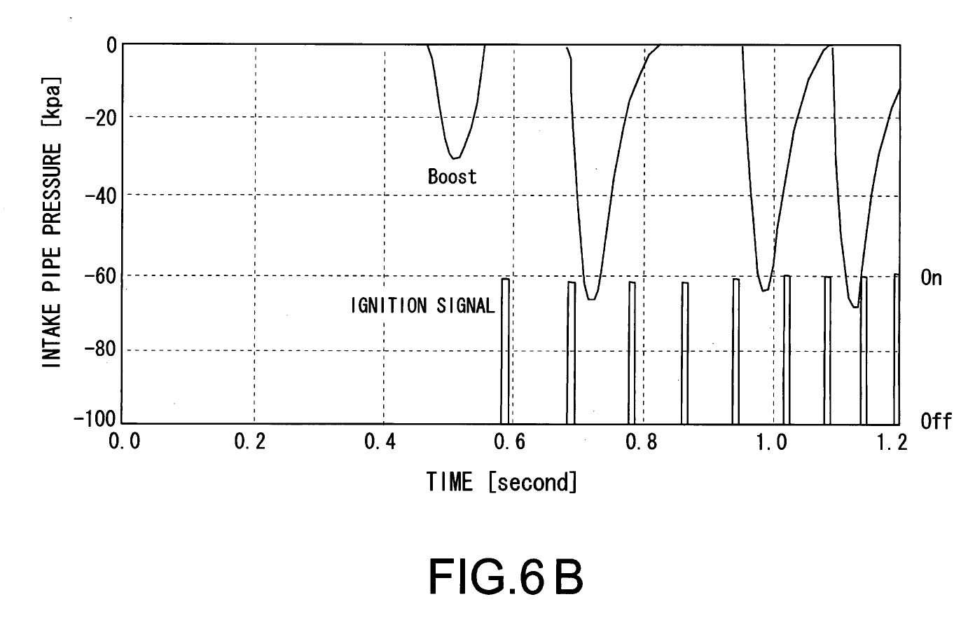

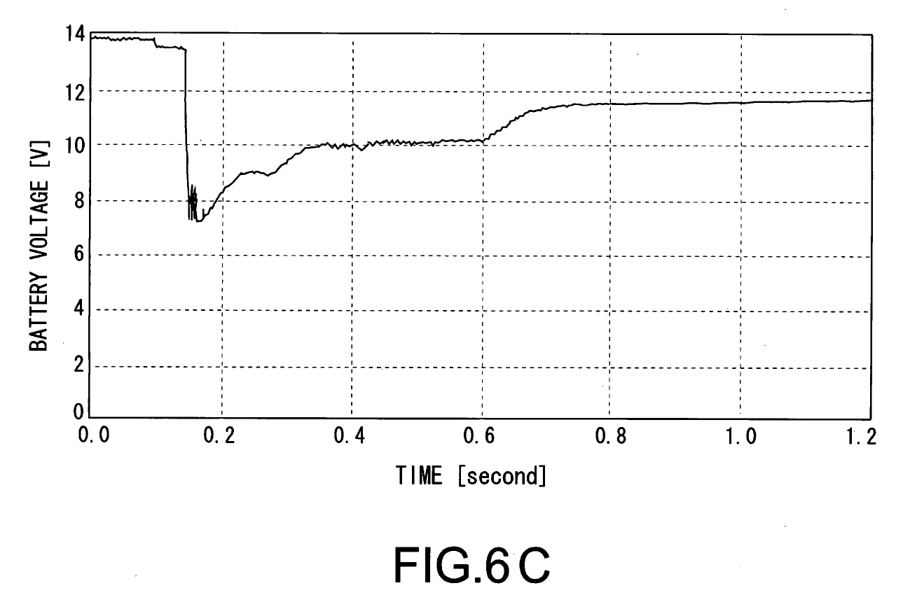

Here, it can be understood from the graph of a battery voltage by the control of a conventional example shown in FIG. 6C that a supply voltage drops markedly, in order to drive a starter motor at the moment of engine starting. Since it can be determined that an electric current flows into the starter motor by detecting this temporary and marked voltage drop, start of the rotation of an engine can be recognized even before an ignition signal is detected.

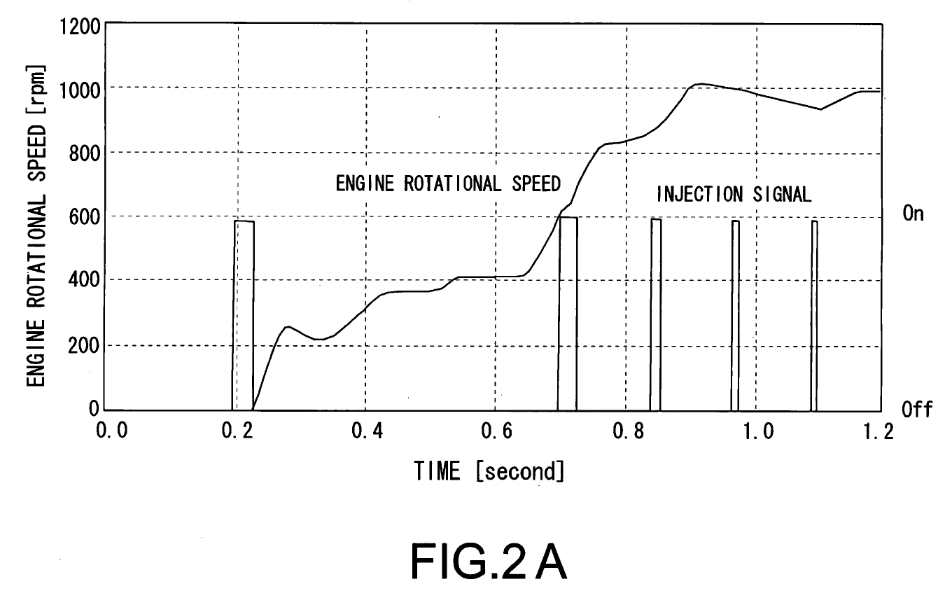

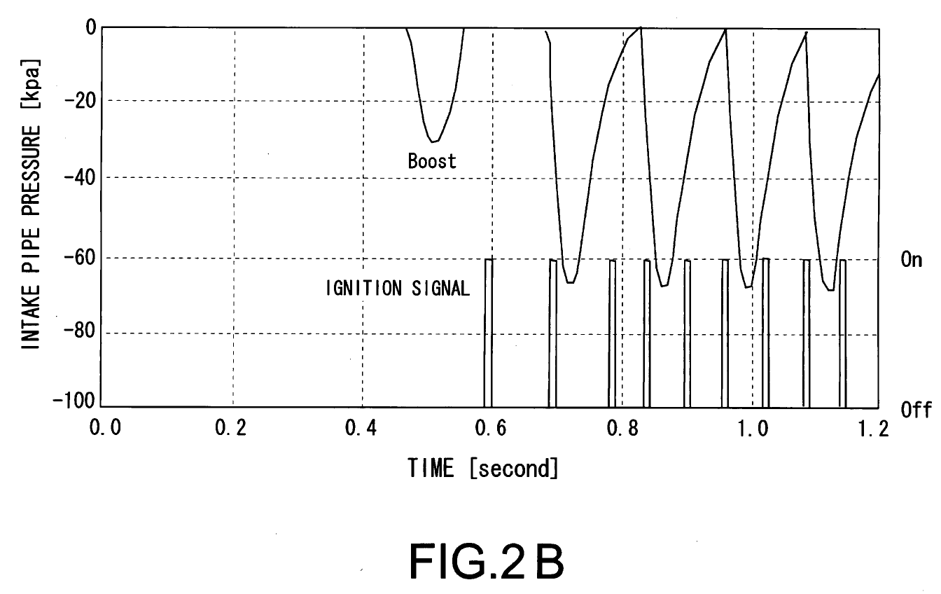

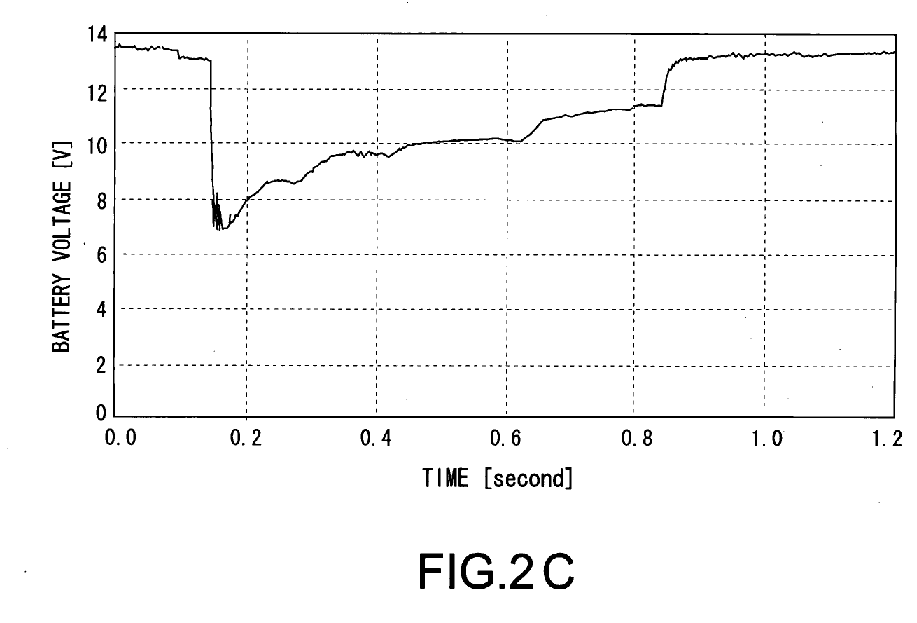

A drop voltage difference that is assumed to be caused by starting of the starter motor from a supply voltage at the time of starting of the electronic control unit 10A is preset as a reference for starting determination. As shown in the graph of FIG. 2C illustrating control results of this embodiment, the electronic control unit recognizes that the engine 1 has started to rotate when a fluctuation (drop) above this reference detects has been caused within a predetermined period from the starting, and then performs a first fuel injection.

By adopting such a fuel injection control method, start of the rotation of the engine 1 can be recognized rapidly and exactly by a relatively simple sequence without laying a superfluous processing burden to an arithmetic part of the electronic control unit 10A. Further, in this embodiment, by recognizing start of the rotation of the engine 1, output of a fuel injection signal is allowed even if any engine rotation signal (ignition signal) is not detected. After the engine rotation signal is detected, the control unit shifts to fuel injection control at the time of normal starting.

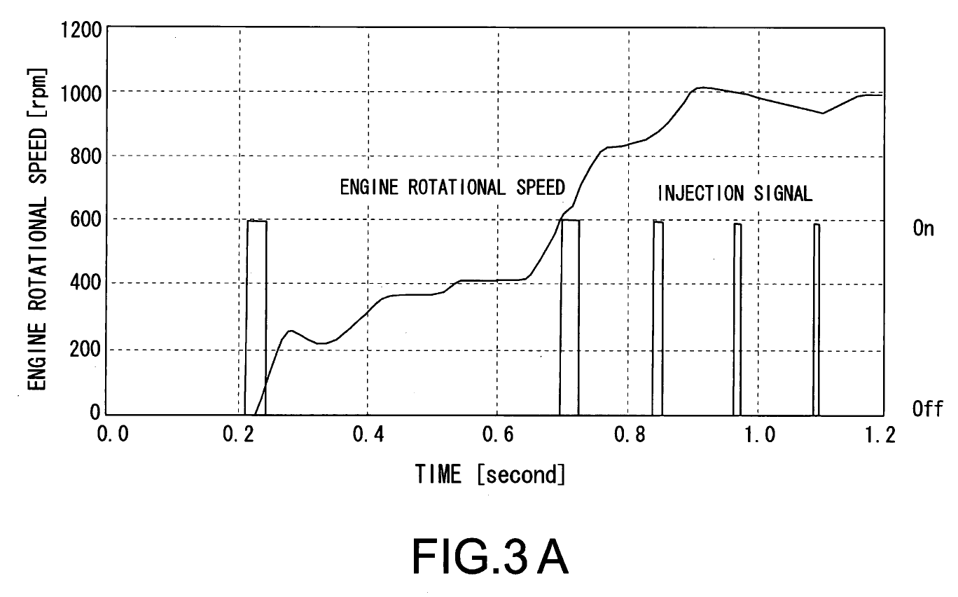

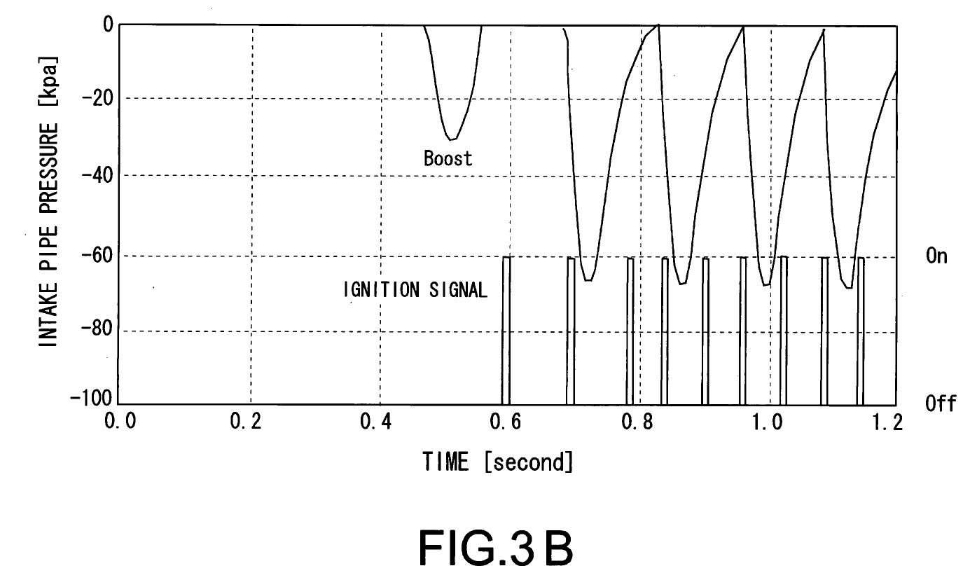

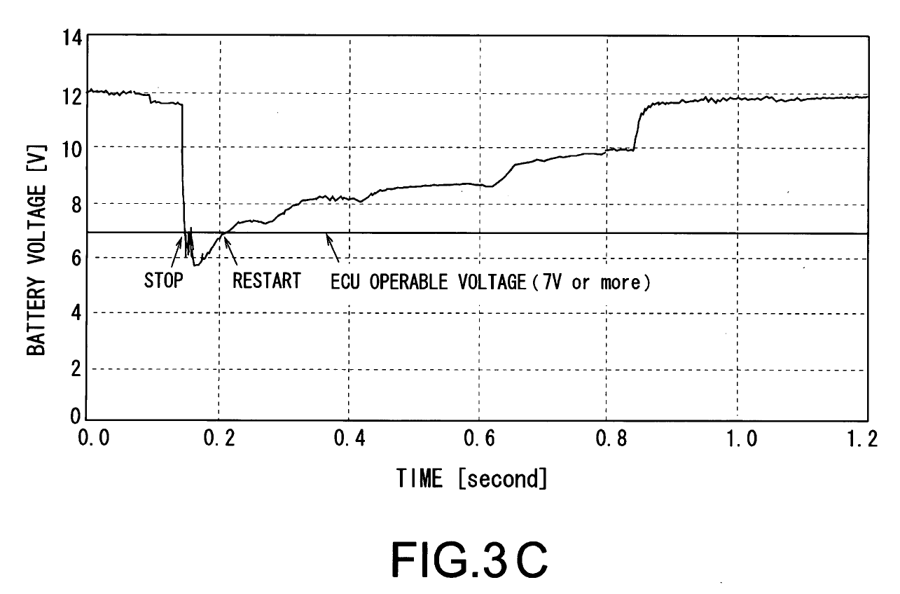

Meanwhile, as shown in the graph of FIG. 3C illustrating the control results of this embodiment, the supply voltage from the battery may become lower than a minimum operating voltage (7 V in the graph) of the electronic control unit 10A, and thereby, the electronic control unit 10A may stop temporarily. Therefore, the supply voltage at the time of restart will normally rise from a low state. Accordingly, in this case, start of the rotation of an engine cannot be recognized by the aforementioned method.

Thus, by utilizing the fact that the supply voltage gradually rises from a low state after restart of the electronic control unit 10A, start of the rotation of the engine 1 is recognized when it is determined that the supply voltage at the time of starting of the electronic control unit 10A is below a predetermined voltage value as a reference for starting determination or when it is determined that a voltage rise within a predetermined period from starting is above a predetermined rising voltage difference as a reference for starting determination, and fuel injection is performed before an ignition signal is input.

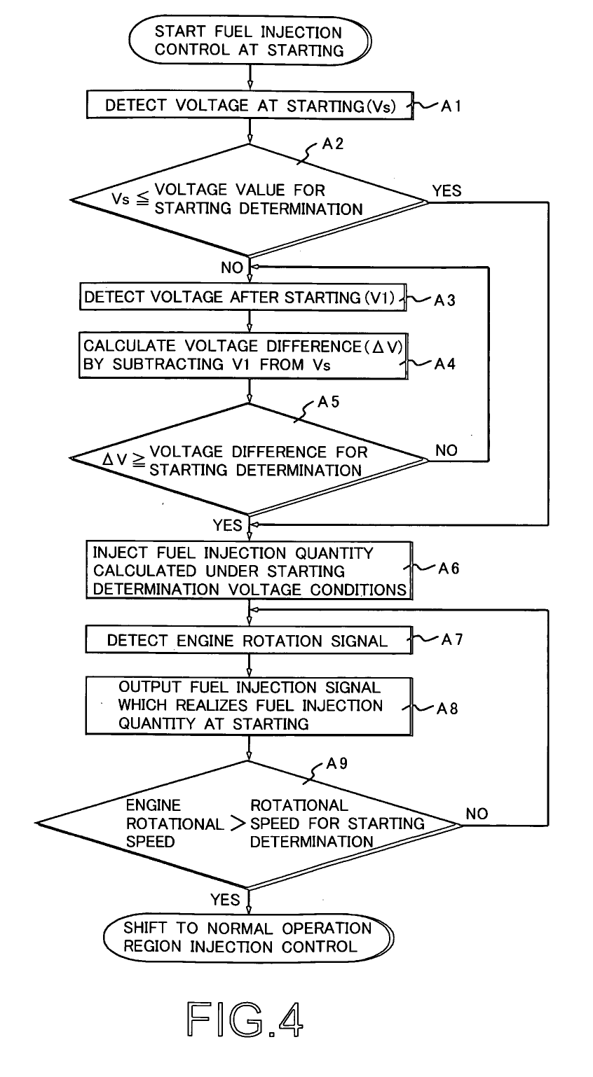

Next, a control sequence by the electronic control unit 10A that is a fuel injection control device of this embodiment will be described in detail with reference to the flow chart of FIG. 4. When a power source of the electronic control unit 10A is turned on, fuel injection control is started at the time of starting. Then, the electronic control unit 10A detects the voltage (Vs) at the time of starting (A1), and determines whether or not this value is below a voltage value for determination at the time of starting (A2). Then, if the voltage at the time of starting (Vs) is below the voltage value for determination at the time of starting, the electronic control unit starts fuel injection (A6). If not, the electronic control unit detects a voltage (V1) after starting (A3), and calculates a voltage difference (ΔV) by subtracting the voltage (V1) after starting from the voltage (Vs) at the time of starting detected in Step A1 (A4).

Then, the electronic control unit determines whether or not this voltage difference (ΔV) is a value above a voltage difference for starting determination for determining predetermined engine starting (A5). If the voltage difference is above the voltage difference for starting determination, the electronic control unit recognizes start of the rotation of an engine, and makes the injector 5 inject fuel as much as a fuel injection quantity calculated under starting determination voltage difference conditions (A6), and if not, the electronic control unit detects the voltage (V1) after starting again (A3).

Thereafter, if an engine rotation signal has been detected (A7), the electronic control unit outputs a fuel injection signal which realizes the fuel injection quantity at the time of starting as usual, and makes the injector 5 perform fuel injection (A8). If the electronic control unit has detected that the engine rotational speed exceeds the rotational speed for starting determination which becomes a reference of the operation at the time of starting (A9), the electronic control unit shifts to normal operation range injection control, and ends fuel injection control at the time of starting.

As shown in the graph of the timing of fuel injection at the moment of engine starting by the control of this embodiment shown in FIG. 2A, FIG. 2B, FIG. 3A and FIG. 3B, it can be understood that start of the rotation of an engine can be recognized even if any ignition signal is not input by detecting a battery supply voltage at the moment of engine starting. Thereby, the timing with which fuel is injected becomes earlier, and the injection before an intake stroke at an early state of engine starting is allowed. As a result, it is possible to inject fuel into a cylinder in every one cycle.

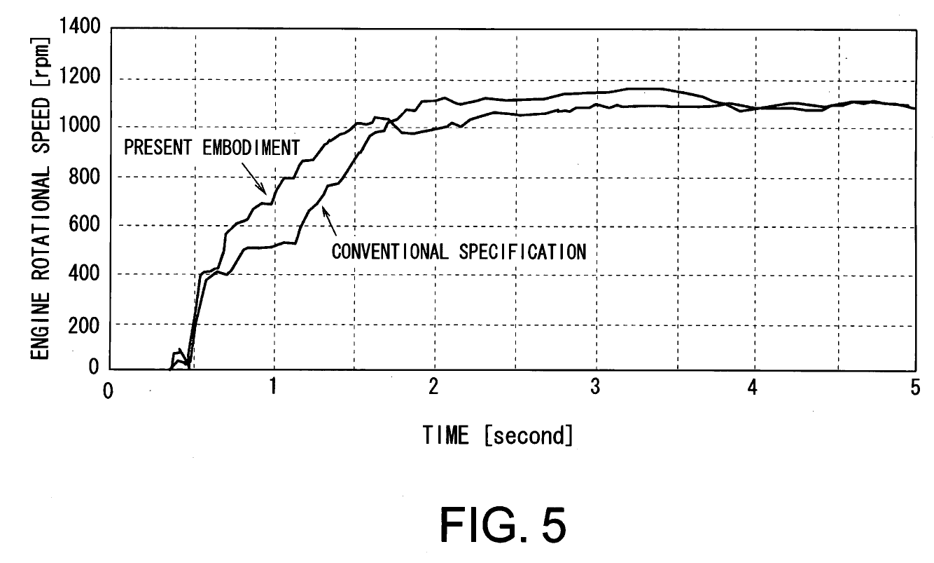

FIG. 5 is a graphical view illustrating a comparison between the engine rotational speed measured by the control of this embodiment and the engine rotational speed measured by the control of the conventional specification, at the moment of engine starting. It can be understood from this graph that, in the conventional specification, there is delay of one cycle until the engine rotational speed increases from immediately after engine starting, whereas in the specification of this embodiment, the engine rotational speed starts smoothly because there is almost no delay.

The fuel injection control method at the moment of engine starting by this embodiment can be easily installed simply by installing a fuel injection control program for executing the aforementioned fuel injection control method in storage means of a fuel injection control device disposed in a conventional fuel injection system. As a result, it is possible to construct a fuel injection system in which any delay of a fuel injection does not occur at the moment of engine starting easily at low cost.

As described above, in the fuel injection control system of an engine in which an engine rotation signal is input to the fuel injection control device only once per one rotation of an engine, according to the invention, delay of a fuel injection start at the moment of engine starting can be avoided without causing soaring of cost, and engine startability or feeling at the time of starting can be improved.

1. A method of permitting a fuel injection control device constituting a part of a fuel injection system of an engine to generate a fuel injection signal according to an engine operation state while determining a fuel injection timing by an input engine rotation signal, and to output the fuel injection signal to an injector, thereby controlling fuel injection of the engine,
wherein the fuel injection control device continuously detects a supply voltage thereto, and recognizes starting of a rotation of the engine when it is detected that a predetermined fluctuation has occurred in the supply voltage at a time of starting of the fuel injection control device or when it is determined that the supply voltage at the time of starting of the fuel injection control device is equal to or below a predetermined reference voltage value, and starts a fuel injection even before inputting of the engine rotation signal.

2. The fuel injection control method of an engine according to claim 1,
wherein the predetermined fluctuation of the supply voltage includes a case where a fluctuation has occurred above a predetermined falling voltage difference or rising voltage difference as a determination reference of engine starting from a voltage value at the time of starting of the fuel injection control device, and where a fluctuation has occurred within a predetermined period from starting of the fuel injection control device.

3. The fuel injection control method of an engine according to claim 1,
wherein shifting to fuel injection control at the time of normal starting is carried out by detecting output of the engine rotation signal after starting of a rotation of the engine is recognized and a first fuel injection is performed.

4. The fuel injection control method of an engine according to claim 2,
wherein shifting to fuel injection control at the time of normal starting is carried out by detecting output of the engine rotation signal after starting of a rotation of the engine is recognized and a first fuel injection is performed.

5. A fuel injection control device for carrying out the fuel injection control method of an engine according to claim 1,
wherein storage means is configured to store therein a fuel injection control program for executing said fuel injection control method, and the fuel injection control device is arranged in a fuel injection system of an engine in such a manner that an electric power is supplied from a battery to drive a starter motor of the engine.

6. A fuel injection control device for carrying out the fuel injection control method of an engine according to claim 2,
wherein storage means is configured to store therein a fuel injection control program for executing said fuel injection control method, and the fuel injection control device is arranged in a fuel injection system of an engine in such a manner that an electric power is supplied from a battery to drive a starter motor of the engine.

7. A fuel injection control device for carrying out the fuel injection control method of an engine according to claim 3,
wherein storage means is configured to store therein a fuel injection control program for executing said fuel injection control method, and the fuel injection control device is arranged in a fuel injection system of an engine in such a manner that an electric power is supplied from a battery to drive a starter motor of the engine.

8. A fuel injection control device for carrying out the fuel injection control method of an engine according to claim 4,
wherein storage means is configured to store therein a fuel injection control program for executing said fuel injection control method, and the fuel injection control device is arranged in a fuel injection system of an engine in such a manner that an electric power is supplied from a battery to drive a starter motor of the engine.
